(19) United States
(12) Patent Application Publication
(10) Pub. No.: US 2023/0267539 A1
(43) Pub. Date: Aug. 24, 2023

(54) MODIFYING RISK MODEL UTILITIES

(71) Applicant: JPMorgan Chase Bank, N.A., New York, NY (US)

(72) Inventor: Logan MALLORY, Chicago, IL (US)

(73) Assignee: JPMorgan Chase Bank, N.A., New York, NY (US)

(21) Appl. No.: 17/678,542

(22) Filed: Feb. 23, 2022

(51) Int. Cl. G06Q 40/02

(52) U.S. Cl. CPC G06Q 40/025

(57) ABSTRACT

In one example, a method for modifying a risk model utility is disclosed. The method includes executing, based on the one or more data objects, a selected risk model utility to generate a risk assessment score. Such execution may be by generating for display a risk model modification user interface to display multiple or plural risk model utilities. Each one of the risk model utilities includes logical risk expressions to generate the risk assessment score. Here, the logical risk expressions may be modifiable. The one or more data objects can store the selected risk model utility and any modifications of the logical risk expressions associated with the selected risk model utility.

### BACKGROUND

Industry best practices along with financial regulations may mandate that financial institutions conduct financial risk assessments of all new and existing customers. An example of such a financial regulation is the GFCC (Global Financial Crimes Compliance) regulation. Another example is the AML (Anti-Money-Laundering/know-your-customer) regulation. Such financial regulations may include provisions that facilitate oversight of financial institutions and their customers/clients.

### BRIEF DESCRIPTION OF THE DRAWINGS

Examples of the disclosure will be rendered by reference to specific examples which are illustrated in the appended drawings. The drawings illustrate only particular examples of the disclosure and therefore are not to be considered to be limiting of their scope. The principles here are described and explained with additional specificity and detail through the use of the accompanying drawings.

FIG. 1 illustrates a system for assessing data records to determine customer financial risks according to an example of the present disclosure.

FIG. 2 illustrates an example of a risk model and a customer pool syntax for the logic engine of FIG. 1.

FIG. 3A is an object-oriented syntax to add an amount of points to the total of a risk assessment score of a customer.

FIG. 3B illustrates a customer-pool syntax in accordance with examples of the present disclosure.

FIG. 4 illustrates a logical risk expression for a risk rule according to an example of the present disclosure.

FIG. 5 illustrates a risk model user interface of a risk model/impact analysis platform according to an example of the present disclosure.

FIG. 6 illustrates a “Select a Risk Model to Edit” webpage according to an example of the present disclosure.

FIG. 7 illustrates a “Select a Customer Pool” webpage according to an example of the present disclosure.

FIG. 8 illustrates a “Release Risk Model” webpage according to an example of the present disclosure.

FIG. 9 illustrates examples of variables of FIG. 8.

FIG. 10 illustrates examples of constants of FIG. 8.

FIG. 11 illustrates examples of thresholds of FIG. 8.

FIG. 12 illustrates examples of components of FIG. 8.

FIG. 13 illustrates examples of customer risk factors of FIG. 8.

FIG. 14 is an example of a risk model structure illustrating the structural relationship between elements of the Release Risk Model of FIG. 8.

FIG. 15 illustrates a method for modifying a risk model utility (such as release risk model 602 of FIG. 6) according to an example of the present disclosure.

FIG. 16 illustrates a non-transitory computer-readable storage medium having stored thereon code instructions according to an example of the present disclosure.

### DETAILED DESCRIPTION

A risk model/risk assessment model and its associated logic rules engine may be used to conduct financial risk assessments of new and existing customers. Specifically, the risk model can be used to determine a customer's overall score, a category-specific risk score, and whether the customer is a low, medium or high financial risk customer. Many such risk models often need to be updated for any number of reasons. The updates may be to account for changing geopolitical environments or changes in risk assessment rules or other unforeseen variables.

However, implementing a risk model update can be an arduous task because when any model update is implemented, a corresponding impact analysis of that update must also be performed. An impact analysis determines whether or not the updated logic rules will adversely impact any existing customer data. As an example, the updated risk model should not incorrectly classify a low financial risk customer as being high risk. This entire process, including the update and the corresponding impact analysis, can take many months to complete.

And even worse, if the impact analysis reveals an adverse impact, the entire update is discarded. The process is then restarted and repeated with the appropriate logic changes thus taking much longer.

Further, although the risk model changes are often business tasks, implementations of such changes are effectuated by software engineers and application developers. The business process owners must then wait on the developers to turn around the updates and redeployment. The turnaround time can be several weeks to a few months depending upon the software cycle and the workload of the application developers.

Accordingly, examples of the present disclosure address the foregoing by providing a method and computer program product for modifying a risk model utility. The method executes, based on one or more data objects, a selected risk model utility to generate a risk assessment score.

For some examples, the method executes the selected risk model utility by generating for display a risk model modification user interface that displays multiple (or plural) risk model utilities or representations thereof. The multiple risk model utilities may include logical risk expressions to generate the risk assessment scores. And the logical risk expressions are modifiable. For some examples, the logical risk expressions are plain English risk rules that involve of a combination of queries that return a true or false value. Consequently, users can easily and quickly edit the logical risk expression via the risk model modification user interface.

Execution of the selected risk model utility is further facilitated by using the one or more data objects to store the risk utility model and any modification of the logical risk expressions that are associated with the risk model utility. In this manner, elements of risk model utilities may quickly and easily edited by business users, and moreover, such business users need not have a software or coding background. Software engineers may also edit logical elements without hard coding resulting in much faster turnarounds when changes are made to risk model utilities. Changes to a selected risk model may be saved in editable data object files separate and apart from hard-coded software.

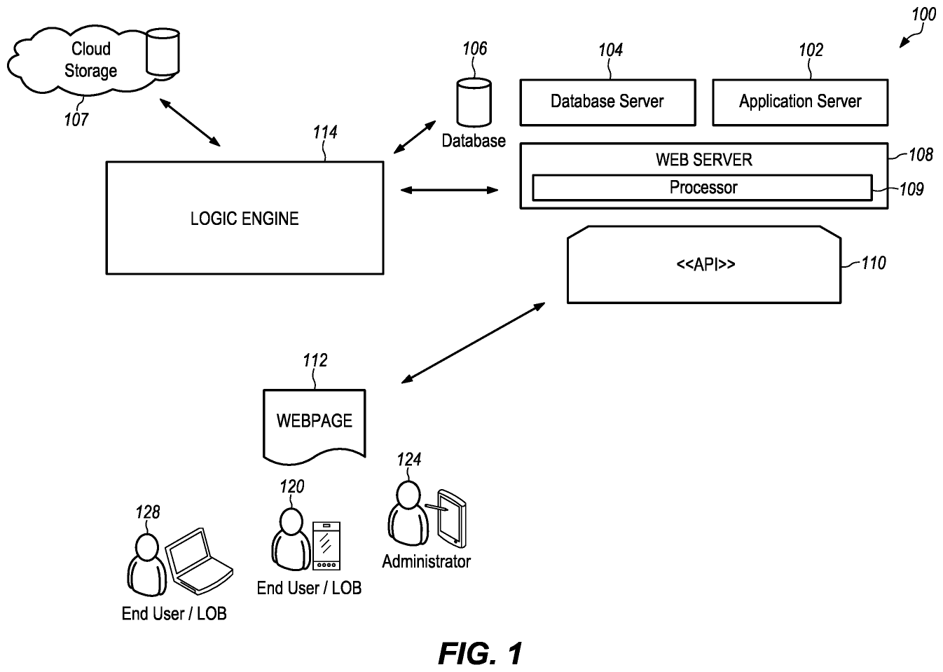

FIG. 1 illustrates a system 100 for assessing data records to determine customer financial risks according to an example of the present disclosure. In FIG. 1, the system 100 includes an application server 102 and a database server 104.

As implied by its name, database server 104 is a computing server that uses a database application, e.g., SQL (Structured Query Language), to manage data on one or more databases 106. The data management (by database server 104) may include storing, retrieving and authenticating end-user access to all of the data stored on database 106. Database 106 may also store customer records (of a financial entity, for example).

Application server 102 may include computing software or code to execute web or desktop applications for use by system 100. Application server 102 may also include runtime libraries and connectors to database 106. As shown, application server 102 may be behind a web server 108 (including a processor 109).

Web server 108 may be a combination of software and/or hardware that accepts HTTP requests initiated via a webpage 112. Any one of end user 120 and end user 128 may initiate communication via webpage 112 by making a request for a specific resource using HTTP. Then the web server 108 can respond with either the content of that resource or with an error message.

In one implementation, end user 128 may request via webpage 112 to add, edit or delete customer records; responsively, web server 108, in conjunction with application server 102 and database server 104, may fulfill the user request. Similarly, an administrator 124 may be tasked to implement risk model changes (via webpage 112 or other internal user interfaces within the enterprise data network).

As used in the present disclosure, a risk model is a list of risk rules that can be applied to a pool of customers to generate risk assessment scores. An example of such a risk rule is “V:politically-exposed=“Yes” OR V:client-country-codes in C:high-risk-countries.”

In FIG. 1, system 100 further includes an API (Application Programming Interface) 110 and a logic engine 114 that are used to apply logic rules to data such as the customer records of an entity including financial institutions or other entity types. Logic engine 114 may be a module, software, or program (usually self-contained) that takes in a set of variables and corresponding values, evaluates a set of predefined conditions, and builds a result set based on true conditions.

API 110 may be a set of communication protocols to receive user requests to analyze the impact of risk model changes on customers as will be further described below. Such requests may then be delivered to logic engine 114 for execution. Similarly, for some examples, API 110 may receive customer scoring requests from other applications and then deliver the customer scoring requests to logic engine 114 for execution.

As shown in FIG. 1, the logic engine 114 may be communicably coupled to a cloud storage 107 and database 106. As implied by its name, cloud storage 107 may be a remotely stored cloud such as S3™ to store available risk models. In contrast, because database 106 is local and within a secure enterprise data network (not shown), database 106 may store customer records and other highly sensitive data.

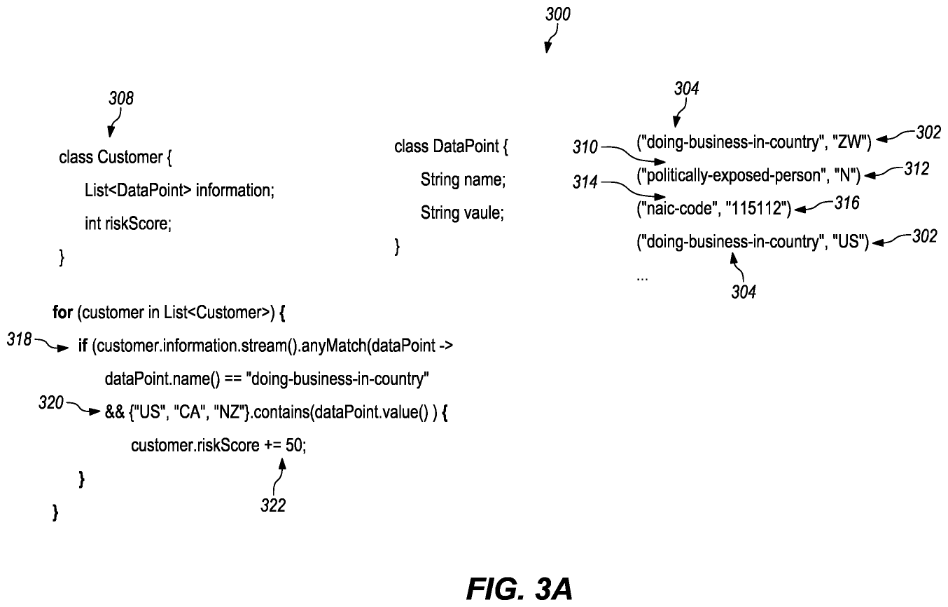

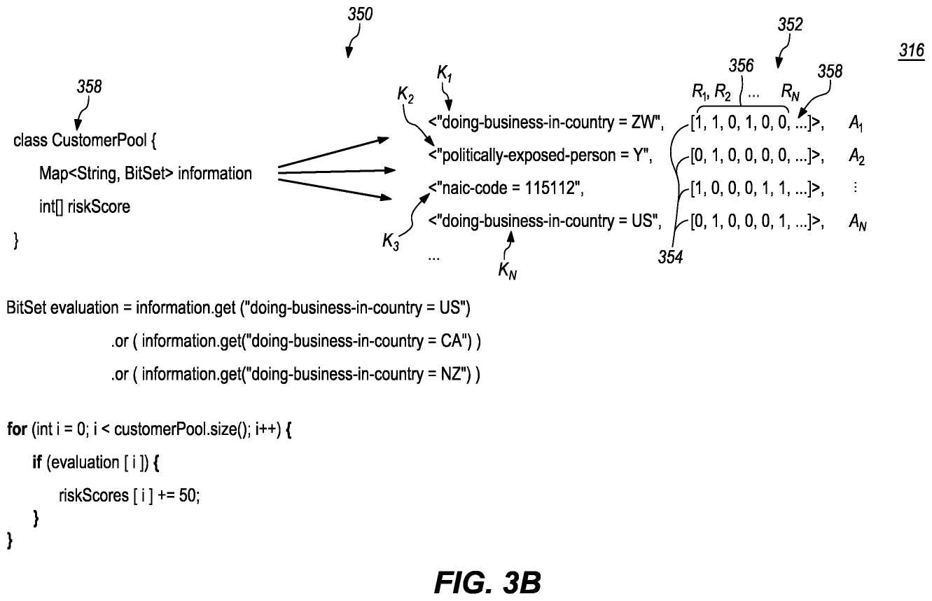

Specifically, for some examples, the present disclosure combines customer records into a customer data pool to achieve compression of large amounts of data and to facilitate the generation of risk assessment scores and the corresponding impact analysis. Here, a customer data pool, as used herein, is composed of values from across a plurality of customer records (e.g., R₁, R₂ . . . N^{th} of FIG. 3B). For example, a first customer record may have the following values or datapoints: name=John Doe; doing-business-in-country=ZW, CA; politically-exposed-person=No; naic-code=115112. A second customer record R₂ may have: name=Jane Doe; doing-business-in-country=ZW, US; politically-exposed-person=Yes; naic-code=441221. An N^{th} customer record R_{N} may include: name=Peter Doe; doing-business-in-country=CA; politically-exposed-person=No; industry-code=441221.

Based on the above, a first customer data pool for above records may include the names: John Doe, Jane Doe, and Peter Doe. In other words, a customer data pool includes values from a row of a plurality of customer records. Another example of a customer data pool based on the above records may include the datapoints: doing-business-in-country=NZ; doing-business-in-country=CA; naic-code=441221; and doing-business-in-country=US. Further yet, another example of a customer data pool includes the values: naic-code=115112, naic-code=441221.

As further described below with reference to FIG. 3B, the customer data pools may be stored as a plurality of arrays where the same position of the plurality of arrays is associated with each individual record and a plurality of keys may be mapped to the data pool of each array.

In one implementation, the present disclosure achieves aggressive data compression resulting in a 100× (one hundred-fold) magnitude increase in data compression by restructuring customer records from a data structure where each customer record has its own individual dataset to a data structure where customer records are combined into a customer data pool.

Briefly, in operation, end user 128 may be an internal end user from a line of business (LOB) of a financial entity. End user 128 may desire a financial risk assessment score for a new customer. End user 128 begins by using webpage 112 to send a financial risk assessment score request to API 110 and web server 108.

In turn web server 108 and/or application server 102 may include one or more processors to cause the logic engine 114 to apply logic rules to the customer data pool (having restructured and compressed customer data) to generate a risk assessment score. Specifically, logic engine 114 may request the latest risk model from cloud storage 107. Logic engine 114 then uses the risk model to score the customer or collection of customers identified in the request.

End user 120 may also employ system 100 to view the impact of changes to risk models. End user 120 may send a request to view the impact of changes that have been made to a particular risk model by end user 120. System 100 receives the request and causes logic engine 114 to request the target customer pool from database 106. Logic engine 114 then applies logic rules based on the modified risk model to the customer data pool (having restructured compressed customer data) and then displays the impact change results to end user 120.

The impact change results might include the level of risk (high, medium or low) or a risk assessment score. Such a level of risk or risk assessment score may reveal that the change to the modified risk model has inadvertently misclassified a low risk customer into a higher risk category (for example). In such cases, end user 120 may discard the modified risk model and restart the risk model revision process. The impact change results may also include evaluations of the risk assessment rules used to score the customer records that may indicate the relative importance of each rule. Additionally, impact change results may be further summarized by their associated risk category.

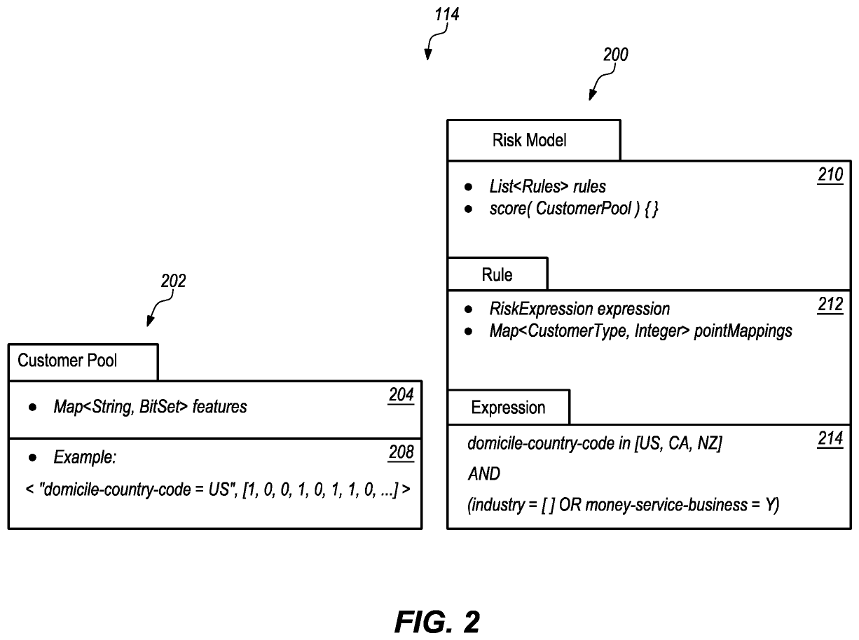

FIG. 2 illustrates an example of a risk model 200 and a customer pool 202 syntax for logic engine 114 of FIG. 1. In one example, logic engine 114 may be caused by a processor (e.g., 109 of FIG. 1) to apply logic rules to BitSet values of customer pool 202.

In FIG. 2, customer pool 202 may include a map 204 object that maps a string (key) to a BitSet of 1s and 0s: map<string, bitset> features. As an example, at 208, the key “domicile-country-code=US” is mapped to the BitSet [1, 0, 0, 1, 0, 1, 1, 0, . . . ].

The risk model 200 may include a list 210 interface that implements multiple rules such as rule 212. The rule 212 may itself be based on a logical combination of expressions 214 such as “domicile-country-code in [US, CA] AND (industry=[ ] OR money-service-business=Y) as in FIG. 2.

FIG. 3A is an object-oriented syntax 300 to add an amount of points to the total of a risk assessment score of a customer 308. Specifically, in FIG. 3A, line of code 318 illustrates that if customer 308 is doing business in the US, CA, or NZ as shown at 320, a 50-point score (shown at 322) is added to the customer's risk assessment score. In this case, the key (question or datapoint) doing-business-in-country 304 has a country code value ZW for Zimbabwe, and US for United States, as depicted as 302. Because customer 308 is doing business in the US, the 50-point score is assigned to customer 308. As such, the risk assessment score of customer 308 is higher indicating that customer 308 may be a higher-risk customer.

Two additional keys, namely politically-exposed-person 310 and naic-code 314, also facilitate risk assessment of a customer. Here, politically-exposed-person 310 has a value N for “no” as shown at 312 and naic-code 314 has a value of 115112 as shown at 316. Note also that if customer 308 were operating in the motorcycle dealership industry (North American Industry Code (NAIC) 441221), object-oriented syntax 300 would include the following key (or datapoints or questions):

class DataPoint {(“naic-code”, “441221”).

To successfully execute the above lines of code, each and every customer record has its own customer 308 object, and its own data set. In other words, for each customer, all of the data including responses to the above questions are stored in a customer 308 object for the customer. As such, if a financial institution has 100 million customers, then 100 million customer objects are stored in memory so that memory consumption by the data structure is a substantial and sizeable 4 TB of memory. The data structure for such a syntax can be very unwieldy and inefficient.

Moreover, scoring 100 million customer objects in this manner takes about 21 days even though memory consumption is low because customers are scored one by one. This object-oriented syntax 300 can also be very inefficient, analyzing risk model impacts by scoring customers one by one and then aggregating the data.

Unlike the system of FIG. 3A, the present disclosure addresses the foregoing by providing an efficient and fast system that enables utilization and compression of a large amount of data. Accordingly, FIG. 3B illustrates a customer-pool syntax 350 in accordance with examples of the present disclosure. Here, as in FIG. 3A, customer-pool syntax 350 also assigns an amount of points to a total risk assessment score. However, in FIG. 3B, all customers are pooled into a CustomerPool 358. If the pooled customers are doing business in the US, CA, or NZ, a 50 point score is assigned to the customers. Here, unlike the object-oriented syntax 300 of FIG. 3A where each customer has its own data set, the customer-pool syntax 350 of the present disclosure combines and compresses all customer data into a customer data pool.

Specifically, in FIG. 3B, a plurality of customer records R₁, R₂ . . . R_{N} are shown. Here, each one of the values 356 is from a different customer record R₁, R₂ . . . R_{N} combined into a customer data pool 358 or array A₁. For example, the first value 356 is a 1 from customer record R₁. The second value 356 is a 1 from customer record R₂. Thus, the values 356 (1, 1, 0, 1, 0, 0 . . . ) form an array A₁ as previously noted. Note also that the values 356 for the customer data pool 358 are Boolean as will be further described below.

As noted above, in FIG. 3B, each customer record R₁, R₂ . . . R_{N} does not have its own dataset but rather has values 354 that are spread out across a plurality of data pools or arrays A₁, A₂, . . . A_{N}. That is, each individual customer record R₁, R₂ . . . R_{N} is itself composed of values from across the plurality of arrays A₁, A₂ . . . A_{N}. As an example, customer record R₁ has values 1, 0, 1, 0. As another example, customer record R₂ has value 1, 1, 0, 1. Although referred to as records, each customer record R₁, R₂ . . . R_{N} is merely a collection of values in the same position or index of the plurality of arrays A₁, A₂ . . . A_{N}.

The arrays A₁, A₂ . . . A_{N} are all in the same order and also have the same length. Thus, it can be assumed that the first index of each of the arrays A₁, A₂ . . . A_{N} is all the same customer. The second index is all the same customer, and so forth. As noted, the arrays are the same length. If there are 100 million customers in the first array A₁, the next array A₂ also has 100 million customers, and the A_{N}^{th} array has 100 million customers.

An aspect of the present disclosure is that each key (or question) K₁, K₂ . . . K_{N} is respectively mapped to the data pool of each array A₁, A₂ . . . A_{N} (as will be further discussed with reference to FIG. 3). The keys K₁, K₂ . . . K_{N} are themselves restructured to facilitate data compression. Specifically, a key or question that typically has a character sequence for an answer is restructured to incorporate the character sequence into the question. As a result, answers to key questions can be either True or False (Yes or No), which can be represented as a BitSet of 1s and 0s.

For example, a typical question may be: which country are you doing business in? The corresponding answer may be a two-letter country code such as US, CA, NZ, etc. This format requires data storage of questions/responses for each customer. Data compression is facilitated by restructuring such a question to include the country code as follows: “doing-business-in-countries=US.” The answer can then be a 1 if a customer is doing business in the US or a 0 if they are not. Thus, the response for each one of 100 million customers (for example) can be represented by either a 1 or a 0. The result is an array of integers of 1s and 0s as shown in FIG. 3B.

Referring now to FIG. 3B, the arrays A₁, A₂ . . . A_{N} can respectively, form a matrix defined by:

K₁[R₁₁, R₁₂ . . . R_{1N}], K₂[R₂₁, R₂₂ . . . R_{2N}], . . . K_{N}[R_{N1}, R_{N2} . . . R_{NN}], where
K₁=“doing-business-in-countries=ZW,” R₁₁=1, R₁₂=1 and R_{1N}=0;
K₂=“politically-exposed-person=Y, R₂₁=0, R₂₂=1 and R_{2N}=0;
K₃=“naic-code=115112”, R₃₁=1, R₃₂=0 and R_{3N}=1 and
K_{N}=“doing-business-in-country=US, R_{N1}=0, R_{N2}=1 and R_{NN}=1.

As can be seen, the plurality of keys K₁, K₂, K₃ . . . K_{N} are questions, and the data pool values are corresponding Boolean responses to the questions. Thus, for key (question) K₁ “doing-business-in-countries=ZW,” the response “1” indicates that the customer does business in ZW while a “0” indicates that the customer does not do business in ZW. As another example, for key (question) K₃ “naic-code=115112,” a “1” indicates that customer operates in the agriculture industry, and a “0” indicates that customer does not operate in that industry. In this manner, responses are compressed into BitSet of 1s and 0s such that for 100 million customers for example, a data compression goes from 4 TB for the syntax of FIG. 3A to only 40 GB for examples according to the present disclosure.

Moreover, the restructured data format also plays a role in latency. Because the present data has been compressed into an array of 1s and 0s, questions can be answered quickly sometimes in as little as 5 milliseconds by applying a logical OR to each of the questions. For example, if the question that is answered is “Is the customer doing business in the US or CA or CN or NZ?” that answer can be recorded efficiently by taking doing a logical OR of the compressed array of 1's and 0's so that the result is either a 0 or a 1. The result is a fast, efficient risk assessment scoring and updating particularly for big data.

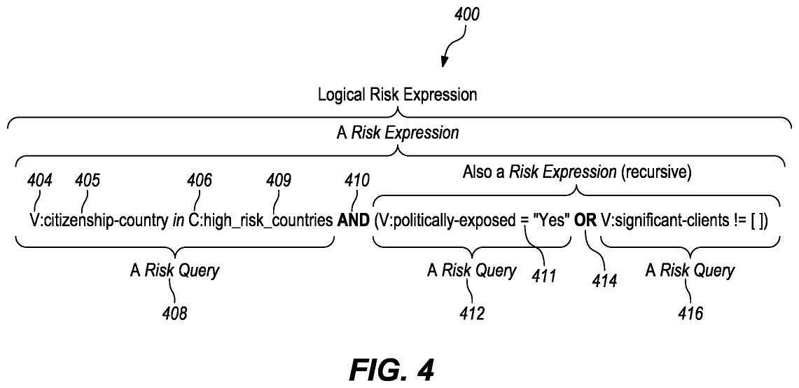

FIG. 4 illustrates a logical risk expression 400 for a risk rule according to an example of the present disclosure. Logical risk expression 400 may be plain English rules that can be interpreted into executable code (e.g., Java code) by a backend engine.

A logical risk expression may be a combination of risk queries joined by a Boolean operator. For some examples, the Boolean operator may be an AND. For other examples, the Boolean operator may be an OR. In another example, a logical risk expression is a combination of risk queries that can be linked using AND, OR, and grouped using parentheses “0.”

A risk rule contains some number of risk queries that produce a final, single output of an array of 0s and 1s. The risk rule also has a mapping of AML (Anti Money Laundering) Customer Type (e.g. FIB (bank), PHS (small business), etc.) to the number of points to assign to the customer if the output is true (value in array=1). Otherwise, the rule adds zero points because the output was false (value in array=0)

In the example of FIG. 4, logical risk expression 400 is comprised of a risk query 408 and a risk query 412 joined by the Boolean operator AND 410 and risk query 412 and risk query 416 joined by the Boolean operator OR 414. A risk query asks a question about a customer (or entity) and returns TRUE or FALSE values. As shown, each risk query 408, 412, 416 may be composed of a variable 404 such as citizenship-country 405 and/or a constant 406 such as C: high_risk_countries 409.

Each risk query 408, 412, 416 may also be composed of an operation such as “=” 411. Although not shown, other examples of operations are “not in,” “in past X days.” Each risk query 408, 412, 416 may also be composed of a target such as “USA,” “MX” and “30 days” (now shown).

For some examples, a risk query may be a single-string query such as:
V:some-variable=“target-1” |Does the customer's values for some-variable contain target-1?

For other examples, a risk query may be a multi-string query such as:

V:some-variable in [“target-1”, “target-2”] |Does the customer's values for some-variable contain target-1 or target-2?

For some examples, a risk query may be a date-query such as:

V:some-variable in past 7 days |Is the customer's value for some-variable in the past 7 days (including current date)?

Although examples of queries have been provided herein, other examples of queries may be used. For example, a risk query may be a rule-query such as:

R:some-existing-rule=True |When the customer was evaluated by the Risk Rule some-existing-rule, was the result true?

Note that the syntax for logical risk expression 400 may employ Boolean-logic (e.g. true AND false-->false), and the syntax may follow the order-of-operations for math so that risk queries inside parentheses are evaluated first. As can be seen, logical risk expression 400 involves the use of plain English rules such that the expressions are easily modifiable by a business user without a software development background.

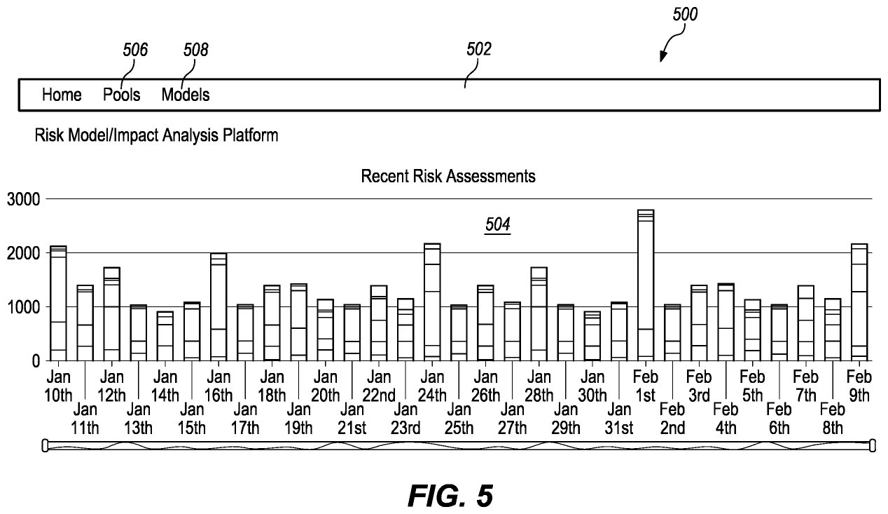

FIG. 5 illustrates a risk model user interface 502 of a risk model/impact analysis platform 500 according to an example of the present disclosure. In this example, the risk model user interface 502 is an Internet web page although other comparable user interfaces may be utilized.

For some examples, risk model user interface 502 can be used to enter plain English changes to the risk model/impact analysis platform 500. And an impact analysis corresponding to the risk model changes may be performed. The impact analysis results may then be presented as a graphical representation, such as bar charts 504.

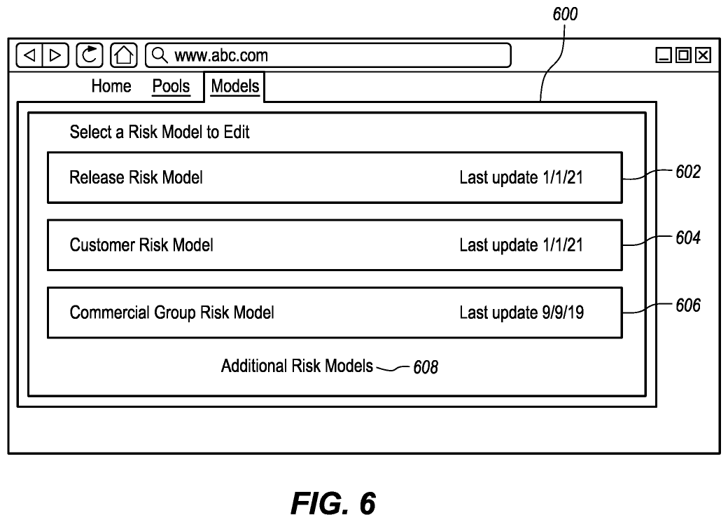

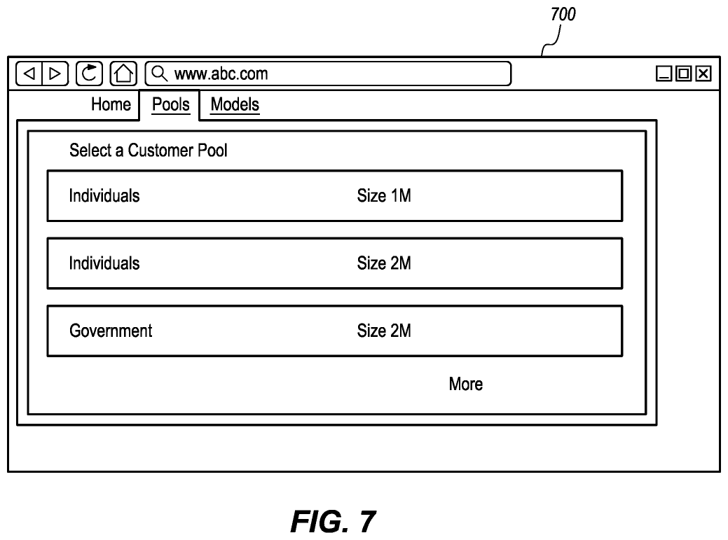

The risk model user interface 502 will now be described with reference to FIG. 5 through FIG. 13. As shown in FIG. 5, the risk model user interface 502 may display two selectable web links: a pools web link 506 and a models web link 508. When selected, models web link 508 may display the “Select a Risk Model to Edit” webpage 600 of FIG. 6 while selection of the pools web link 506 is to display the “Select a Customer Pool” webpage 700 of FIG. 7.

Referring to FIG. 6, “Select a Risk Model to Edit” webpage 600 may display multiple risk models (or representations of thereof) for editing by a user. As shown here, available risk models that may be edited include a “Release Risk Model” 602, a “Customer Risk Model” 604 and a “Commercial Group Risk Model” 606. Selection of the “Additional Risk Models” 608 button can display additional risk models.

As used here, the terms “risk model” and “risk model utility” represent a collection of logical risk expressions based on rules, components and/or customer risk factors with applicable points and weights for generating a risk assessment score to evaluate an entity. The entity may be an individual customer of a financial institution. As another example, the entity may be a business customer of an organization.

In the examples of FIG. 6, the “Release Risk Model” 602 may be a first release model to evaluate the risk associated with an individual customer type. “Customer Risk Model” 604 may evaluate the risk associated with high net worth customers. Commercial Group Risk Model 606 may evaluate risks associated with a commercial group customer of an entity.

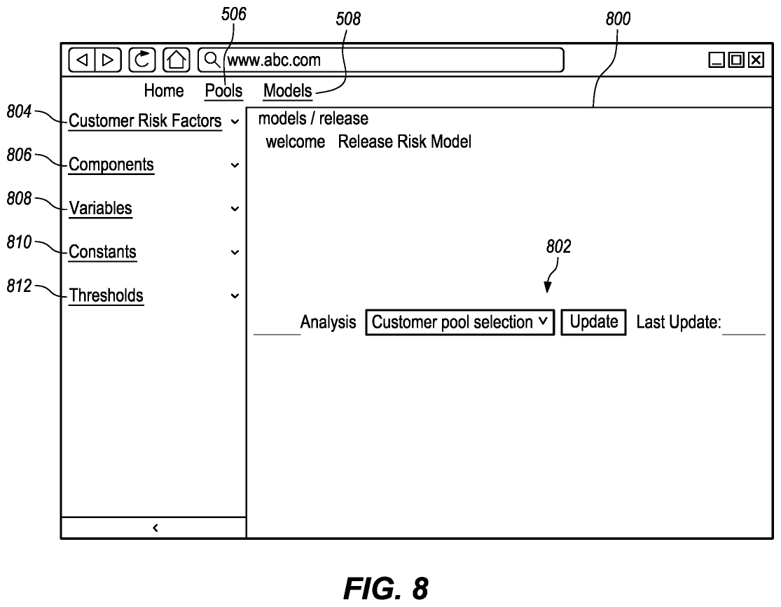

Referring now to FIG. 7, the “Select a Customer Pool” webpage 700 can be used to select specific customer pools for evaluation with a risk model. Here, the “Select a Customer Pool” webpage 700 includes an individual customers pool 702, individual customers pool 704 and government customers pool 706. As shown, the customer pool size may vary for the same customer type. As an example, the size of individual customer pools 702 is 1 million customers and that of individual customer pools 704 is 2 million. The size of the government customers pool 706 is 2 million. The application of a particular customer pool to a risk model is shown in FIG. 8.

FIG. 8 illustrates the “Release Risk Model” webpage 800 according to an example of the present disclosure. For this example, “Release Risk Model” webpage 800 may be used to edit elements of the Release Risk Model and then apply the Release Risk Model to a selected customer pool that may be chosen via drop-down box 802.

Here, as shown on the “Release Risk Model” webpage 800, the elements of a release risk model are customer risk factors 804 and components 806 collectively referred to as logical classifying elements. The other elements are variables 808, constants 810 and thresholds 812 that are used to form logical risk expressions.

For some examples, all of the elements are easily editable via “Release Risk Model” webpage 800. Once the Release Risk Model is edited, the logical element edits may be saved as data objects for communication to a backend engine for parsing and execution of the risk model to facilitate editing and expedite the turnaround time for risk model changes.

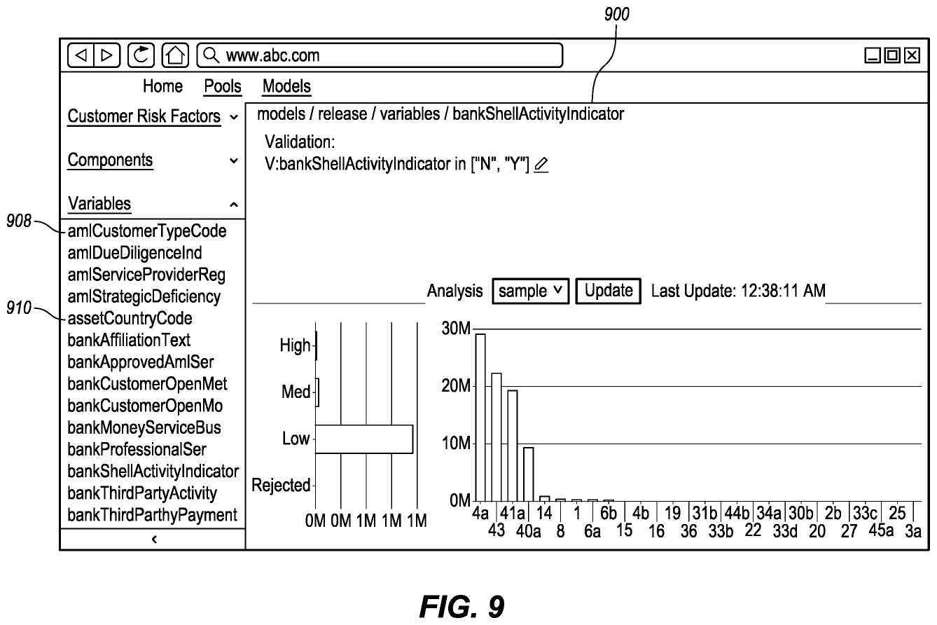

Referring now to FIG. 8, variables 808, constants 810 and thresholds 810 are logical elements that are referenced in or used to structure the rules. Here, variables are customer data risk items that can take on more than one value, and can be referenced within the rules—as previously noted, the Release Risk Model is based on rules. FIG. 9 illustrates examples of variables 808. In FIG. 9, an example of variable 808 is amlCustomerTypeCode 908. amlCustomerTypeCde 908 is a customer type code for indicating a particular type of customer such as anti-money laundering customer code. For example, amlCustomerTypeCode 908 may take on the value GOV for a government.

As another example, amlCustomerTypeCode 908 may take on the value IMM (Individual Mass Market) that indicates that a customer is an individual. A further example of variable 808 is assetCountryCode 910 (FIG. 9) which identifies the location where assets of a particular customer are kept. Although not shown, numerous different types of variables 808 can be employed. As noted, the variables and corresponding values can be employed in the rules.

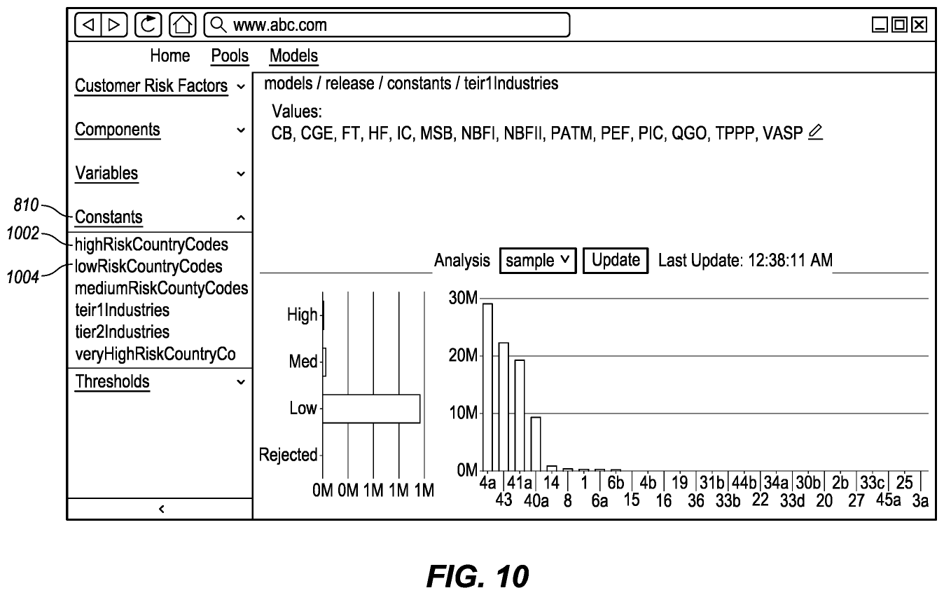

Constants 810 (FIG. 8) may also be referenced in the rules. FIG. 10 illustrates examples of constants 810. Constants 810 are a key-value map to determine, for example, the level of risk of a customer's country or industry. In FIG. 10, an example of constants 810 is highRiskCountryCodes 1002 for high risk countries. highRiskCountryCodes 1002 can take on two-digit codes for countries. As an example highRiskCountryCodes 1002 may take on the value MX, the country code for Mexico to indicate that Mexico is a high risk country. Another example of constants 810 is lowRiskCountryCodes 1004 for low risk countries. Although not shown, numerous different types of constants 810 can be utilized.

Thresholds 812 (FIG. 8) may also be referenced in the rules. Thresholds 812 are the magnitude or the lower limit of the amount of points for a particular rating. For instance, the LOW threshold is 0, the MEDIUM threshold might be 460.

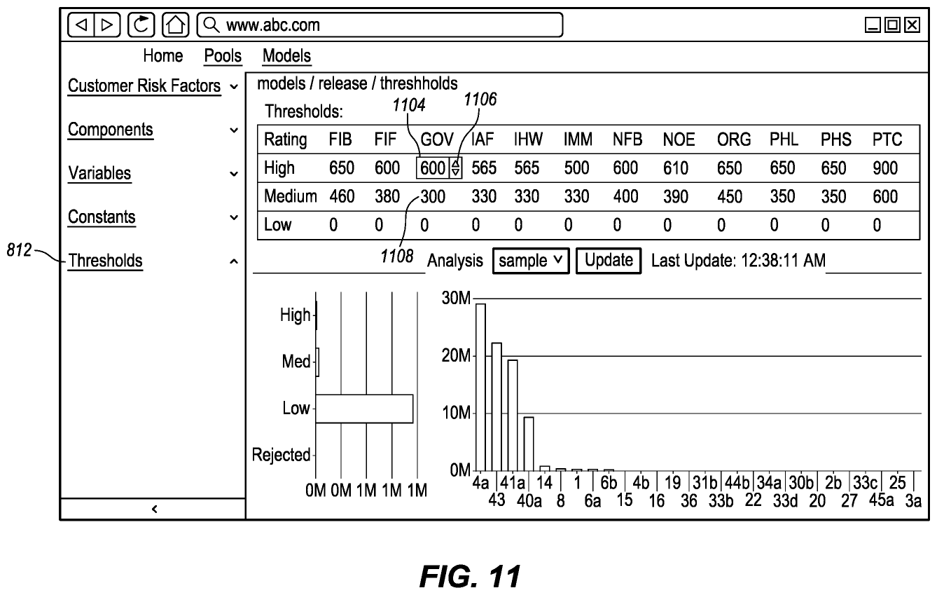

FIG. 11 illustrates examples of thresholds 812. In FIG. 11, threshold 1104 for customer GOV is 600. As such, customer GOV has a high rating if the total amount of points is at least 600. Note also that threshold 1104 may be increased or reduced via a stepper button 1106 (or by typing in a value). Threshold 1108 for customer GOV is 380. Therefore, if the amount of points calculated for customer GOV is 380 or higher, customer GOV is assigned a medium rating.

Another element that is accessible via the “Release Risk Model” webpage 800 is components 806. As discussed below, components 806 are a tier above the rules, and they categorize the rules. Components 806 may include one or more rules that relate to similar attributes/transactions, etc., of a customer.

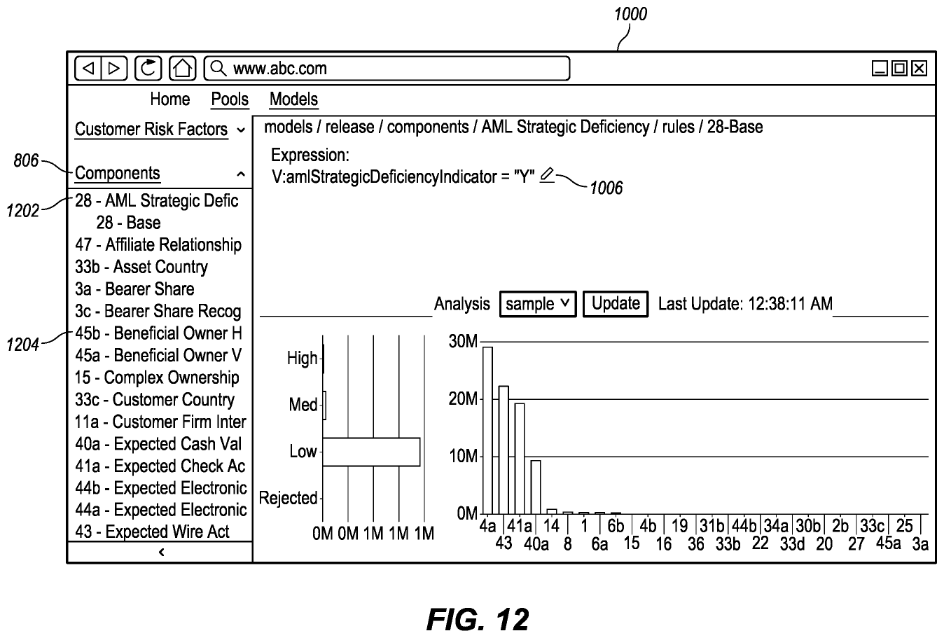

FIG. 12 illustrates examples of components 806. As shown, a first example of components 806 is “Beneficial Owner High Risk Country” 1204, which has logic rules to determine whether an account has a beneficial owner in a high-risk country. Another example is “AML Strategic Deficiency” 1202, which identifies jurisdictions with strategic deficiencies in their anti-money laundering policies. An example of such a rule is amlStrategicDeficiencyIndicator=“Y” 1206 to indicate that this particular jurisdiction has strategic deficiencies in its anti-money laundering policies.

Here, the value of amlStrategicDeficiencyIndicator is editable by a user and may take on the value “Y” for yes or “N” for no. Such editable plain-English values adapt the present disclosure for use by both business users that have no software knowledge as well as software engineers/developers.

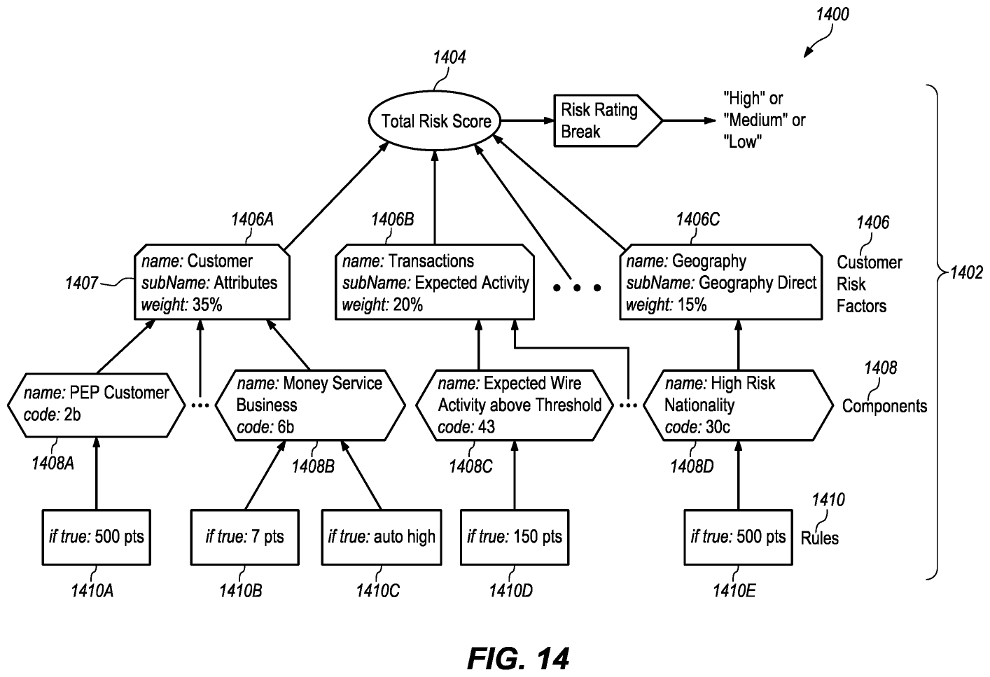

Referring now to FIG. 8, another element of “Release Risk Model” webpage 800 is customer risk factors 804. Customer risk factors 804 are a parent category above components 806 and are used to categorize components 806 as further described with reference to the risk model structure of FIG. 14 below. Customer risk factors 804 may also assign weights to determine the relative importance of the of the customer risk factors.

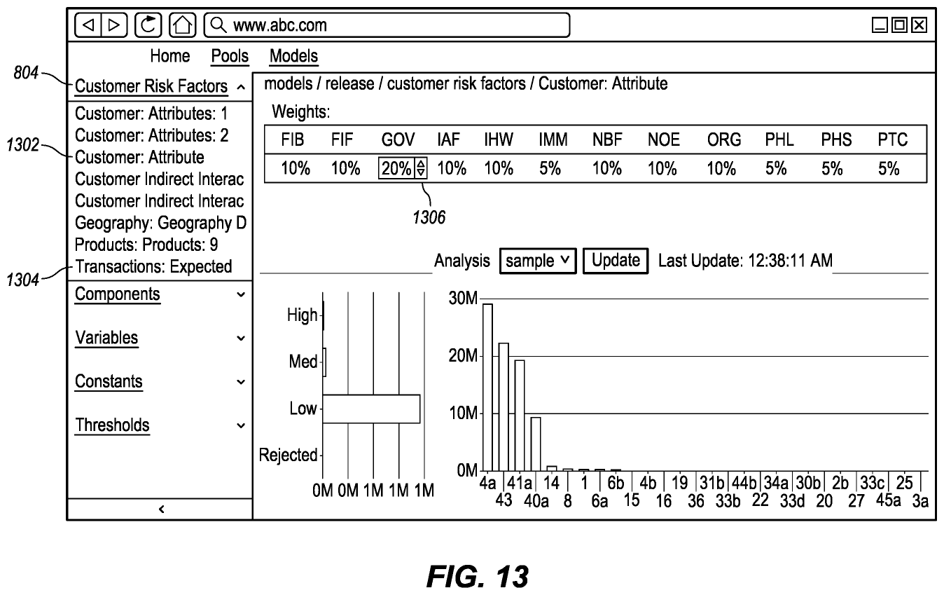

FIG. 13 illustrates examples of customer risk factors 804. As an example, customer attributes 1302 may categorize components that relate to attributes or characteristics of a customer. Customer risk factors 804 add up their components points, and apply a weight based on AML customer type (i.e., weight*sum (component points). A customer risk factor may also indicate the expected transaction levels for a customer as shown by transactions: expected activity 1304. Further, as shown at 1306, weights may be assigned to particular customer risk factors. As shown, a 20% risk is assigned to customer GOV.

In use, as noted above, each of the above logical elements may be edited by business users, and such business users need not have a software or coding background. Moreover, software engineers may also edit logical elements without coding resulting in much faster turnarounds. Changes to a selected risk model may be saved via a save button (not shown). The changes may be saved to one or more data object files that can then be communicated to a backend engine for parsing and execution without the need to modify hard coded software to enter changes.

FIG. 14 is an example of a risk model structure 1400 illustrating the structural relationship between elements of the Release Risk Model of FIG. 8. Specifically, risk model structure 1400 shows a hierarchal structure 1402 of the risk model elements including a total risk score 1404 above the hierarchy and rules 1410 at the bottom of hierarchal structure 1402. The total risk score 1404 can be determined based on the rules 1410, components 1408 and customer risk factors 1406 that are above the rules 1410.

In FIG. 14, the rules 1410, which are positioned at the bottom tier of the hierarchy include rule 1410A, rule 1410B, rule 1410C, rule 1410D and rule 1410E. When the rules 1410 are true, points are assigned to the customer. Thus, if rule 1410A is true, 500 pts are assigned to the customer. An example of logic that can be used to assign points for rule 1410a is: “Is naic-code=525997 AND assets-country-code in C:high-risk-country-codes,” then add 500 points to the customer.” Here, the variables “naic-code” and “assets-country-code” are attributes/risk Items of the customer which can be utilized for assessing risk. The values 525997 and C:high-risk-country-codes are undesirable and would drive a customer to be considered more high risk.” Many hundreds of rules may be based on the use of such risk items.

As used herein, risk items are the variables that an end user can use or reference to write risk queries. Examples are “domicile-country-code”, “politically-exposed-person”. The variable names are used as keys to lookup/query binary/compressed data discussed above. So, if a Risk Query is “domicile-country-code in [“US”, “CN”]”, the system retrieves the compressed arrays of 0s and 1s for the keys “domicile-country-code=“US””, and “domicile-country-code=“CN””, and performs a bitwise logical OR on the arrays, because the Risk Query should evaluate to True if the customer is living in the US or China.

Points may also be similarly assigned if the other rules 1410 are true. If rule 1410B is true, for example, 7 pts are assigned. If rule 1410C is true, the customer rating is set to auto-high. If rule 1410D is true, 150 pts are assigned to the customer; and if rule 1410E is true, 500 pts are assigned. Note here that for some examples, rules may automatically force a customer to be considered HIGH risk, no matter how many points they accumulate. In other examples, some rules may force a customer to automatically be considered LOW or MEDIUM risk regardless of their points.

The tier immediately above rules 1410 is occupied by components 1408. Components 1408 may group and then sum up those rules 1410 that are related. For example, component 1408A (PEP Customer) groups rule 1410A and the sum is 500 pts. Component 1408B (Money Service Business) groups together both of rules 1410B and 1410C. The sum of both rules is auto-high. Component 1408C (Expected Wire Activity above Threshold) may group rule 1410D for which the sum is 150 pts. And component 1408D (High Risk Nationality) may group rule 1410E for a sum of 500 pts.

The tier immediately above components 1408 is occupied by customer risk factors 1406. Here, customer risk factors 1406 categorize components 1408 and obtains the sum of all components associated with a particular customer risk factor. The sum is then weighted by weights 1407 to control the relative importance of each customer risk factor 1406.

Specifically, customer risk factor 1406A categorizes components that relate to customer attributes including component 1408A that relates to a PEP (politically exposed persons) customer and component 1408B that relates to a money service business. The sum of component 1408A and component 14088 is then weighted by 35% as shown.

Customer risk factor 14068 categorizes components that relate to transactions: expected activity including component 1408C that relates to expected wire activity above a threshold. The sum resulting from component 1408C is weighted by 20%.

Customer risk factor 1406C categories components according to a customer's geography including component 1408D relating to whether the customer has a high risk nationality. As shown, the resulting sum from component 1408D is weighted by 15%. The total risk score 1404 is the sum of the customer risk factors 1406A, 1406B and 1406C each multiplied by its applicable weight.

In an example operation, assume that a customer triggers rule 1410A, 14108, 1410D and 1410E so that the rules are true. Then the score for component 1408A is 500 pts based on rule 1410A, the score for component 1408B is 7 pts based on rule 14108 and 1410C (not true), the score for component 1408C is 150 pts based on rule 1410D and the score for component 1408D is 500 pts based on rule 1410E.

Thus, the customer risk factor 1406A score is 500 pts+7 pts based on components 1408A and 1408B. This score is then weighted by 35% for a total of 177.45 pts. The customer risk factor 1406B score is 150 pts based on component 1408C, this score is then weighted by 20% for a total of 30 pts. And the customer risk factor 1406C score is 500 pts based on component 1408D. This score is weighted by 15% for a total of 75 pts. Thus, the total risk score 1404 for the customer is 177.45 pts+30 pts+75 pts=282.5 pts.

Parsing/Compiling Risk Expressions

The structure below illustrates an example data object structure of a Risk Model. Although the structure is illustrated in JSON, any comparable data format may be utilized.

```
{
  “name”: “release”,
  “version”: 6,
      “risk-items”: [ ... ],
  “risk-parameters”: [ ... ],
    “customer-risk-factors”: [ ... ],
    “risk-components”: [ ... ],
  “risk-ratings”: [ ... ]
}
```

The Risk Model name and version are used to create a new RiskModelId class (value object, no behavior). For each Risk Item in the list, a new RiskItem class object (value object, has no behavior) is created. For each Risk Parameter in the list, a new RiskParameter class object (value object, has no behavior) is created. Here, Risk Parameters are constants that can be referenced in risk queries, for example, in “doing-business-in-country-code in C:high-risk-country-codes,” the values of the constant C (i.e. high-risk-country-codes) can be edited through the user interface, and users can remove or add new constants as well.

For each Customer Risk Factor in the list, a new CustomerRiskFactor class object (value object, has no behavior) is created. For each Risk Component in the list, a new RiskComponent class object (value object, has no behavior) is created. For each Risk Rule in the Risk Component's list of rules: a new RiskRule class object (has behavior, like ‘BitSet evaluate(CustomerPool) { . . . }’) is created. Risk Queries are parsed here, and an error is thrown if the syntax is invalid.

For each Risk Rating in the list, a new RiskRating class object (value object, has no behavior) is created. Finally, a new RiskModel class object (has behavior) is created and the following are passed to it:

RiskModelId
Set<RiskItem>
Set<RiskParameter>
Set<RiskRule<Integer>>
Set<RiskRule<RiskRating>>
Set<RiskRating>

The RiskModel object then validates that: There are no duplicate Risk Items, Risk Parameters, Customer Risk Factors, Risk Components, Risk Rules, or Risk Ratings. The Risk Items (variables), Risk Parameters (constants), and Risk Rules referenced by Risk Queries are all present in the RiskModel object. The Customer Risk Factor weights and Risk Rating thresholds are found for all customer types. The RiskModel object may then be used to score and analyze Customer Pools.

The structure below illustrates an example data object structure of a Customer Risk Factor. Although the structure is illustrated in JSON, any comparable data format may be utilized.

```
          {
      “number”: 3,
      “name”: “CUSTOMER”,
      “sub-name”: “ATTRIBUTES”
      “is-auto-rating-type”: false
      “weights”: [
    {
        “aml-customer-type”: “IMM”,
        “due-diligence-type”: “conventional”,
        “weight”: “40”
    },
    {
        “aml-customer-type”: “IMM”,
        “due-diligence-type”: “tailored”,
        “weight”: “35”
    },
    {
        “aml-customer-type”: “PHS”,
        “due-diligence-type”: “conventional”,
        “weight”: “15”
    }
  ]
}
```

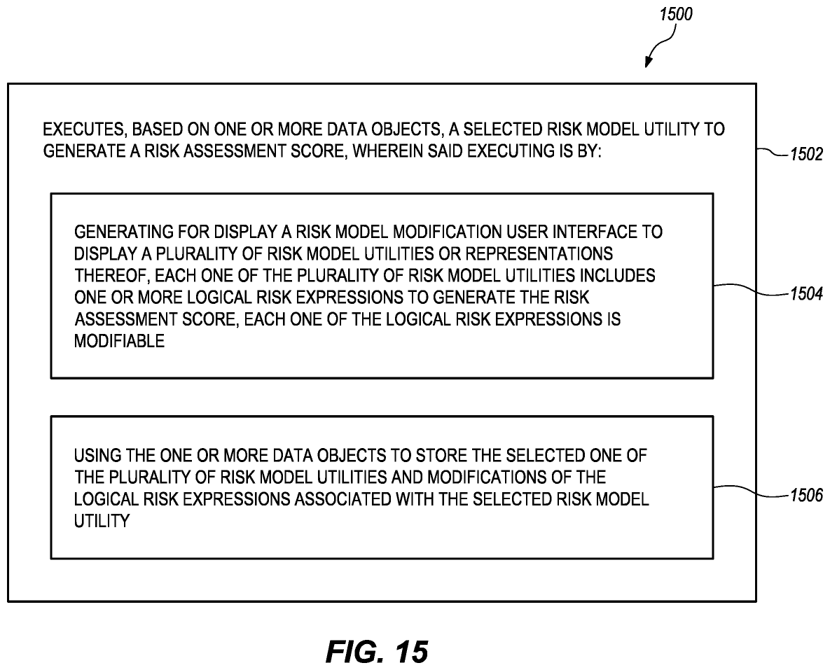

FIG. 15 illustrates a method 1500 for modifying a risk model utility (such as release risk model 602 of FIG. 6.

The operation begins at block 1502, wherein method 1500 executes, based on one or more data objects (such as a JSON file), a selected risk model utility 602 (FIG. 6) to generate a risk assessment score 1404 (FIG. 14).

At block 1504, the executing may be by: generating for display a risk model modification user interface “Select a Risk Model to Edit” webpage 600 (FIG. 6) that is to display a plurality of risk model utilities 602, 604, 606, 608 (FIG. 6) or representations thereof. Each one of the plurality of risk model utilities 602, 604, 606, 608 includes one or more logical risk expressions 400 (FIG. 4) to generate the risk assessment score (total risk score) 1404. Each of the logical risk expressions 400 may be modified.

At block 1506, executing of the selected risk model utility 602 may also be by using the one or more data objects to store the selected one 602 of the plurality of risk model utilities 602, 604, 606, 608 and modifications of the logical risk expressions 400 associated with the selected risk model utility 602.

In an example, method 1500 may include one or more logical classifying elements 804, 806 (FIG. 8) for generating the risk assessment score. Each one of the logical classifying elements 804, 806 is selectable for editing and storage in said one or more data objects. The logical classifying elements may include components 806 to categorize risk rules. The logical classifying elements may also include customer risk factors 804 to categorize the components 806. For some examples, risk rules for logical risk expressions 804, 806 are comprised of a combination of queries 408, 414 that return a true or false value and are based on Boolean logic.

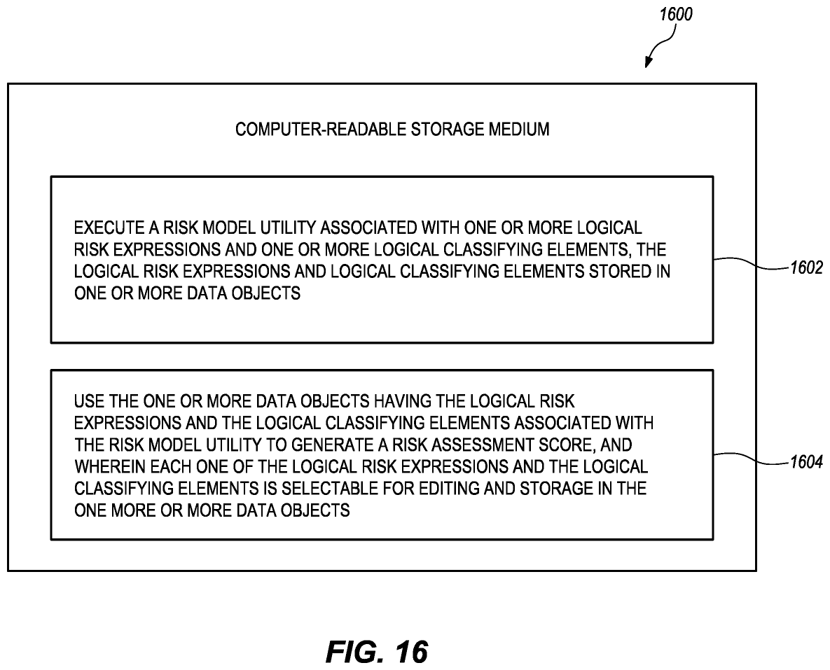

FIG. 16 illustrates a non-transitory computer-readable storage medium 1600 having stored thereon code instructions 1602 and 1604, which can be executed by a processor (e.g., 109).

Code instructions 1602 may cause processor 109 (FIG. 1) to execute a risk model utility 602 (FIG. 6) associated with one or more logical risk expressions 400 (FIG. 4) and one or more logical classifying elements 804, 806 (FIG. 8), the logical risk expressions 400 and logical classifying elements 804, 806 stored in one or more data objects (such as a JSON file).

Code instructions 1604 cause the processor 109 to use the one or more data objects having the logical risk expressions 400 and the logical classifying elements 804, 806 associated with the risk model utility 602 to generate a risk assessment score 1404 (FIG. 4). Each one of the logical risk expressions 400 and the logical classifying elements 804, 806 is selectable for editing and storage in the one more data objects.

The present disclosure may employ a software stack to enlist the underlying tools, frameworks, and libraries used to build and run example applications of the present disclosure. Such a software stack may include PHP, React, Cassandra, Hadoop, Swift, etc. The software stack may include both frontend and backend technologies including programming languages, web frameworks servers, and operating systems. The frontend may include JavaScript, HTML, CSS, and UI frameworks and libraries. In one example, a MEAN (MongoDB, Express.js, AngularJS, and Node.js) stack may be employed. In another example, a LAMP (Linux, Apache, MySQL, and PHP) stack may be utilized.

Any suitable programming language can be used to implement the routines of particular examples including Java, Python, JavaScript, C, C++, assembly language, etc. Different programming techniques can be employed such as procedural or object oriented. The routines may execute on specialized processors.

The specialized processor may include memory to store a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a software program.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

While the above is a complete description of specific examples of the disclosure, additional examples are also possible. Thus, the above description should not be taken as limiting the scope of the disclosure which is defined by the appended claims along with their full scope of equivalents.

1. A method for modifying a risk model utility, the method comprising:
executing, based on one or more data objects, a selected risk model utility to generate a risk assessment score, wherein said executing is by:
generating for display a risk model modification user interface to display a plurality of risk model utilities or representations thereof, wherein each one of the plurality of risk model utilities includes one or more logical risk expressions to generate said risk assessment score, wherein each one of the logical risk expressions is modifiable; and
using the one or more data objects to store the selected one of the plurality of risk model utilities and modifications of the logical risk expressions associated with the selected risk model utility.

2. The method of claim 1 wherein each logical risk expression is comprised of risk rules.

3. The method of claim 1 further comprising one or more logical classifying elements for generating said risk assessment score and wherein each one of the logical classifying elements is selectable for editing and storage in said one or more data objects.

4. The method of claim 2 wherein the risk rules are comprised of a combination of queries that return a true or false value and are based on Boolean logic.

5. The method of claim 3 wherein the logical classifying elements are comprised of components to categorize risk rules.

6. The method of claim 3 wherein the logical classifying elements are comprised of customer risk factors to categorize the components.

7. The method of claim 1 wherein a structure of the one or more data objects is based on JSON.

8. The method of claim 1 further comprising parsing the one or more data objects to execute the selected risk model utility.

9. The method of claim 1 further comprising, receiving from a website the one or more data objects for execution by a backend server.

10. A computer program product for modifying a risk model utility, the computer program product embodied in a non-transitory computer-readable storage medium embodied having stored thereon code instructions which, when executed by a processor, cause the processor to:
execute a risk model utility associated with one or more logical risk expressions and one or more logical classifying elements, the logical risk expressions and logical classifying elements stored in one or more data objects; and
use the one or more data objects having the logical risk expressions and the logical classifying elements associated with the risk model utility to generate a risk assessment score and wherein each one of the logical risk expressions and the logical classifying elements is selectable for editing and storage in the one or more data objects.

11. The computer program product of claim 10 further comprising generating for display a risk model modification user interface displaying a plurality of risk model utilities or representations thereof, wherein said risk model utility is selected from the plurality of risk model utilities.

12. The computer program product of claim 10 wherein the logical risk expression is based on a combination of variables and constants that return a true or false value.

13. The computer program product of claim 10 wherein the logical classifying elements include components which categorize risk rules to generate the risk assessment score.

14. The computer program product of claim 10 wherein the logical classifying elements are comprised of customer risk factors to apply weighted values to the risk assessment score.

15. The computer program product of claim 10 wherein the risk rules are comprised of a combination of queries that return a true or false value and are based on Boolean logic.

16. The computer program product of claim 10 further comprising causing the processor to: parse the one or more data objects to execute the selected risk model utility.

17. The computer program product of claim 10 further comprising causing the processor to: generate the risk assessment score based on a hierarchy.

18. The computer program product of claim 17 wherein the hierarchy is based on evaluating risk rules in a lower tier and then evaluating components on a higher tier.

19. The computer program product of claim 10 wherein the risk utility model is structured on a hierarchy having risk rules on a bottom tier, components on a middle tier and customer risk factors on a top tier.
